(19) United States
(12) Patent Application Publication
(10) Pub. No.: US 2012/0152515 A1
(43) Pub. Date: Jun. 21, 2012

(54) AIR CONDITIONER FOR VEHICLE

(75) Inventors: Souta Okabe, Kariya-city (JP); Haruki Misumi, Higashihiroshima-city (JP)

(73) Assignee: DENSO CORPORATION, Kariya-city (JP)

(21) Appl. No.: 13/328,263

(22) Filed: Dec. 16, 2011

(30) Foreign Application Priority Data
Dec. 20, 2010 (JP) 2010-283173

(51) Int. Cl. G05D 23/00

(52) U.S. Cl. 165/287

(57) ABSTRACT

A vehicle air conditioner includes a casing, an inside/outside air switching portion, a cooling heat exchanger, a dew-point detector, and a target temperature determining portion. The casing defines a passage through which air to be blown into a vehicle compartment passes. The inside/outside air switching portion switches between inside air and outside air modes. The cooling heat exchanger is arranged in the casing to cool air. The dew-point detector detects a dew-point temperature of air flowing to the cooling heat exchanger. The target temperature determining portion determines a target cooling temperature of the cooling heat exchanger to be lower than the dew-point temperature before a base time elapses, and maintains the target cooling temperature at a target cooling temperature that is set at the elapse of the base time after the base time elapses, in the inside air mode.

### CROSS REFERENCE TO RELATED APPLICATION

This application is based on and incorporates herein by reference Japanese Patent Application No. 2010-283173 filed on Dec. 20, 2010.

### TECHNICAL FIELD

The present invention relates to a vehicle air conditioner which is provided with a cooling heat exchanger.

### BACKGROUND

Conventionally, Patent Document 1 (International Patent Publication No. WO 0007836 A1) discloses regarding a vehicle air conditioner, which is provided with an evaporator of a refrigerant cycle as a cooling heat exchanger. The cooling heat exchanger is used for cooling air to be blown into a vehicle compartment. The vehicle air conditioner is made to prevent bad odor generation in the blown air at the evaporator.

Specifically, the air conditioner in Patent Document 1 controls a refrigerant discharge capacity of a compressor of the refrigerant cycle, such that an evaporation temperature of refrigerant flowing in the evaporator becomes higher or lower by a predetermined degree than a dew-point temperature of the blown air flowing into the evaporator. Accordingly, an outer surface of the evaporator is not dry and wet frequently. Therefore, bad odor generation in the blown air is prevented.

However, when an evaporation temperature of refrigerant flowing in the evaporator is set to be lower than a dew-point temperature of the blown air flowing into the evaporator, temperature of the blown air flowing out of the evaporator becomes too lower than a target set temperature of the vehicle compartment in an inside air mode. In the inside air mode, air inside the vehicle compartment is introduced into the evaporator. In this case, air, which has been dehumidified by the evaporator, flows into the evaporator again in the inside air mode (inside air circulation mode). Thus, the dew-point temperature of the blown air decreases every when air passes through the evaporator again in the inside air mode, and thereby the evaporation temperature of refrigerant flowing into the evaporator also decreases. As a result, temperature of the blown air flowing out of the evaporator decreases gradually.

Accordingly, unnecessary cooling of the blown air may cause increment of consumed power of the compressor. Therefore, energy consumption in the whole vehicle air conditioner may increase.

### SUMMARY

The present invention addresses at least one of the above disadvantages. According to an aspect of the present invention, an air conditioner for a vehicle includes a casing, an inside/outside air switching portion, a cooling heat exchanger, a cooling temperature adjusting portion, a dew-point detector, a target temperature determining portion, a cooling temperature control portion, and an inside/outside air switch control portion. The casing defines an air passage through which air to be blown into a vehicle compartment passes. The inside/outside air switching portion is arranged to switch between an inside air mode, where air inside the vehicle compartment is introduced into the casing, and an outside air mode, where air outside the vehicle compartment is introduced into the casing. The cooling heat exchanger is arranged in the casing to cool air. The cooling temperature adjusting portion is configured to adjust a cooling temperature of air cooled at the cooling heat exchanger. The dew-point detector is configured to detect a physical amount relevant to dew-point temperature of air flowing to the cooling heat exchanger. The target temperature determining portion is configured to determine a target cooling temperature which is a target temperature of the cooling heat exchanger. The cooling temperature control portion is configured to control the cooling temperature adjusting portion so that the cooling temperature approaches the target cooling temperature. The inside/outside air switch control portion is configured to control an operation of the inside/outside air switching portion. The target temperature determining portion sets the target cooling temperature to be lower than the dew-point temperature before a base time elapses when the inside air mode is selected by the inside/outside air switching portion. The target temperature determining portion maintains the target cooling temperature at a target cooling temperature, which is set at the elapse of the base time, after the base time elapses when the inside air mode is selected.

Accordingly, the dew-point temperature of air flowing into the cooling heat exchanger can be prevented from reducing. Thus, it can prevent the temperature of air from being unnecessarily cooled at the cooling heat exchanger in the inside air mode. Therefore, energy consumed for cooling air can be also prevented from increasing. Furthermore, the target cooling temperature can be maintained lower than the dew-point temperature. Hence, even if the target cooling temperature is maintained at a constant value, an outside surface of the cooling heat exchanger can be kept at a moist state. Accordingly, energy consumption in the whole of the air conditioner can be reduced, and generation of bad odor from air blown into the vehicle compartment also can be prevented.

### BRIEF DESCRIPTION OF THE DRAWINGS

The invention, together with additional objectives, features and advantages thereof, will be best understood from the following description, the appended claims and the accompanying drawings in which:

FIG. 1 is a schematic diagram showing an air conditioner for a vehicle, according to a first embodiment of the invention;

FIG. 2 is a flowchart showing a control process of the air conditioner according to the first embodiment and other embodiments;

FIG. 3 is a flowchart showing a part of the control process of the air conditioner according to the first embodiment and other embodiments; and

FIG. 4 is a graph showing a relationship between a target cooling temperature TEO and a cooling temperature Te of air cooled at an evaporator of the air conditioner, from a start of air conditioning operation of the air conditioner according to the first embodiment.

### DETAILED DESCRIPTION OF THE DRAWINGS

Embodiments of the present invention will be described hereinafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

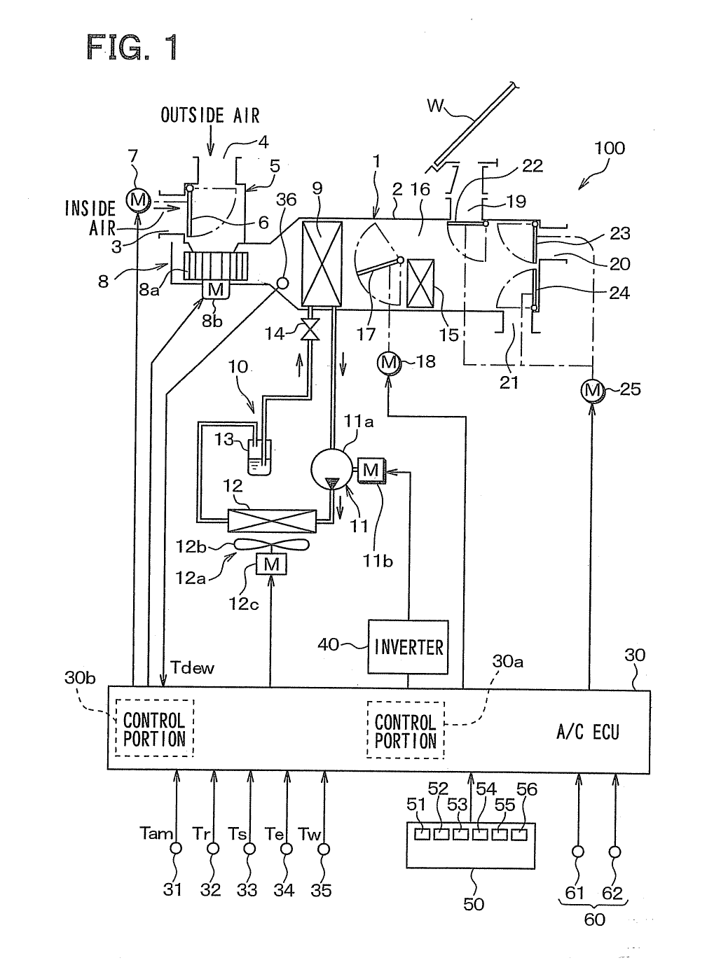

A first embodiment of the invention will be described referring to FIGS. 1 to 4. An air conditioner 100 for a vehicle according to the present embodiment is typically used for a hybrid vehicle which receives a driving force from an internal combustion engine and an electrical motor for driving the vehicle.

A hybrid vehicle can generally switch its running states by actuating or stopping the engine depending on a running load or the like of the vehicle. For example, in one of the running states, driving force is obtained from both of the engine and the electrical motor. In another state, driving force is obtained only from the electrical motor by stopping the engine. Accordingly, the hybrid vehicle can improve its fuel efficiency as compared to a normal vehicle in which driving force is obtained only from an engine.

As shown in FIG. 1, the air conditioner 100 according to the present embodiment includes an air conditioning unit 1, a refrigerant cycle 10, and an air conditioning controller 30 (NC ECU). The air conditioning unit 1 is arranged inside an instrument panel (dashboard) located at a front end of a vehicle compartment. The air conditioning unit 1 includes a casing 2, a blower 8, an evaporator 9, and a heater core 15. The casing 2 accommodates the blower 8, the evaporator 9, the heater core 15 and the like.

The casing 2 is formed of high-strength resin (e.g., polypropylene) having a certain level of elasticity, and defines an air passage through which air flows into the vehicle compartment. At a most upstream side of the casing 2 in a flow direction of the air, an inside/outside air switching box 5 is arranged. The switching box 5 switches between an outside air introduction passage, which introduces outside air, i.e., air outside of the vehicle compartment into the air passage of the casing 2, and an inside air introduction passage, which introduces inside air, i.e., air inside of the vehicle compartment into the air passage of the casing 2.

Specifically, the switching box 5 includes an inside air port 3 and an outside air port 4, which introduce inside air and outside air to the air passage of the casing 2 respectively. An inside/outside air switching door 6 is disposed inside the switching box 5 to adjust open areas of the inside air port 3 and the outside air port 4 continuously, thereby adjusting a ratio between flow amounts of inside air and outside air to be introduced into the casing 2.

Hence, the switching door 6 is used to selectively switch an air inlet mode by adjusting the ratio between the flow amounts of inside air and outside air introduced into the casing 2. The switching door 6 is actuated by a servomotor 7 that is controlled by a control signal output from the air conditioning controller 30.

The air inlet mode includes an inside air mode, an outside air mode, and an inside/outside air mix mode. In the inside air mode, inside air is introduced into the casing 2 by fully opening the inside air port 3 and fully closing the outside air port 4. In the outside air mode, outside air is introduced into the casing 2 by fully opening the outside air port 4 and fully closing the inside air port 3. In the inside/outside air mix mode, the inside air port 3 and the outside air port 4 are opened simultaneously. The switching box 5 is adopted as an example of an inside/outside air switching portion which switches between the inside air mode, where inside air is introduced to the air passage of the casing 2, and the outside air mode, where outside air is introduced to the air passage of the casing 2.

The blower 8 is located at a downstream side of the switching box 5 in the air flow direction. The blower 8 is adopted as an example of a blowing portion. The blower 8 blows air, which has been introduced through the switching box 5, toward the vehicle compartment. For example, the blower 8 is an electrical blower in which a centrifugal multi-blade fan (e.g., sirocco fan) 8a is driven by an electrical motor 8b, and the rotation speed (air blowing amount) of the electrical motor 8b is controlled by a control voltage output from the air conditioning controller 30. Thus, the electrical motor 8b is adopted as an example of a blowing capacity changing portion of the blower 8.

The evaporator 9 is arranged at a downstream side of the blower 8 in the air flow direction. The evaporator 9 is adopted as an example of a cooling heat exchanger where the air to be blown into the vehicle compartment is cooled by heat exchange with refrigerant flowing therein. Specifically, the evaporator 9 is one component of the refrigerant cycle 10, which includes a compressor 11, a condenser 12, a liquid receiver 13, and an expansion valve 14, in addition to the evaporator 9.

The refrigerant cycle 10 will be described below. The compressor 11 is arranged in an engine compartment of the vehicle to draw and compress refrigerant, and then to discharge the compressed refrigerant. The compressor 11 is an electrical compressor in which a fixed-displacement compression mechanism 11a is driven by an electrical motor 11b. The fixed-displacement compression mechanism 11a is configured to discharge a fixed amount of refrigerant. The electrical motor 11b is an alternate motor, and operation (rotation speed) of the electrical motor 11b is controlled by an alternate current output from an inverter 40.

An alternate current output from the inverter 40 has a frequency in accordance with a control signal output from the air conditioning controller 30. Thus, a rotation speed of the compressor 11 is controlled by a frequency control of the air conditioning controller 30, and thereby, a refrigerant discharge capacity of the compressor 11 is also changed by the frequency control. Therefore, the electrical motor 11b is adopted as a discharge capacity changing portion of the compressor 11.

The condenser 12 is arranged in the engine compartment, and cools and condenses refrigerant which has been discharged from the compressor 11. The condensation is performed by heat exchange between the discharged refrigerant flowing out of the compressor 11 and air (outside air) sent from outside of the vehicle compartment by a cooling blower 12a used as an outdoor fan.

The cooling blower 12a is an electrical fan in which an axial fan 12b is driven by an electrical motor 12c. An operation rate, i.e., a rotation speed (air blowing amount) of the electrical motor 12c is controlled by a control voltage output from the air conditioning controller 30. Thus, the electrical motor 12c is adopted as a blowing capacity changing portion of the cooling blower 12a.

The liquid receiver 13 is a gas-liquid separator, which separates refrigerant cooled and condensed by the condenser 12 into gas and liquid to store surplus refrigerant and to discharge only liquid refrigerant downstream. The expansion valve 14 is adopted as an example of a decompression portion which decompresses and expands refrigerant flowing out of the liquid receiver 13. For example, the expansion valve 14 is a thermostatic expansion valve, which regulates a refrigerant amount to be discharged downstream, so that a superheat degree of refrigerant flowing at an outlet of the evaporator 9 is adjusted within a predetermined range.

As the above-described thermostatic expansion valve 14, an expansion valve can be adopted, which includes a temperature sensor located in a refrigerant passage of the outlet of the evaporator 9. The expansion valve 14 detects a superheat degree of refrigerant at the outlet of the evaporator 9 based on a temperature and a pressure of the refrigerant. The expansion valve 14 regulates its open degree (refrigerant amount) by an automatic mechanism such that a superheat degree of refrigerant at the outlet of the evaporator 9 becomes a predetermined value.

Refrigerant, which has been decompressed and expanded at the expansion valve 14, evaporates and exerts its heat absorption effect at the evaporator 9. Accordingly, the evaporator 9 functions as a cooling heat exchanger which cools the blown air. A cooling temperature Te of air flowing out of an air outlet of the evaporator 9 is determined based on an evaporation temperature (evaporation pressure) of refrigerant flowing in the evaporator 9.

Furthermore, in the present embodiment, the thermostatic expansion valve 14, which regulates its open degree by an automatic mechanism, is adopted as the decompression portion. Thus, an evaporation pressure of refrigerant flowing in the evaporator 9 can be determined based on a rotational speed (refrigerant discharge capacity) of the compressor 11. Therefore, the compressor 11 of the present embodiment is adopted as an example of a cooling temperature adjusting portion which adjusts the cooling temperature Te of the air flowing out of the evaporator 9.

The heater core 15 is arranged at a downstream side of the evaporator 9 in the casing 2 in the air flow direction, to heat air passing through the heater core 15 in the casing 2. The heater core 15 is adopted as a heating heat exchanger. The heating heat exchanger heats air (cold air) having passed through the evaporator 9 by using coolant (hot water), which is used for cooling the engine, as a heat source.

A bypass passage 16 is provided at one side of the heater core 15 so that air having passed through the evaporator 9 bypasses the heater core 15 through the bypass passage 16. Thus, temperature of the air mixed at downstream sides of the heater core 15 and the bypass passage 16 changes depending on a ratio between an air flow amount flowing through the heater core 15 and an air flow amount flowing the bypass passage 16.

Thus, in the present embodiment, an air mix door 17 is arranged between the downstream side of the evaporator 9 and an upstream side of the heater core 15 and the bypass passage 16. The air mix door 17 continuously changes the ratio between the air flow amounts of the heater core 15 and the bypass passage 16. Hence, the air mix door 17 is adopted as a temperature adjusting portion, which adjusts the temperature of the air mixed in an air mixing portion at the downstream side of the heater core 15 and the bypass passage 16.

The air mix door 17 is driven by a servomotor 18 which is controlled by a control signal output from the air conditioning controller 30.

At the most downstream side of the casing 2, air outlets 19 to 21 are provided. Conditioned air having been temperature-adjusted is blown from the air outlets 19 to 21 into the vehicle compartment that is a space to be air-conditioned. Specifically, the air outlets 19 to 21 are a defroster air outlet 19, a face air outlet 20 and a foot air outlet 21. The defroster air outlet 19 is provided to blow conditioned air toward an inner surface of a windshield W of the vehicle. The face air outlet 20 is provided to blow conditioned air toward an upper side of a passenger seated on a seat of the vehicle compartment. The foot air outlet 21 is provided to blow conditioned air toward a lower side of the passenger seated on the seat of the vehicle compartment.

A defroster door 22, a face door 23, and a foot door 24 are provided at upstream sides of the defroster air outlet 19, the face air outlet 20 and the foot air outlet 21 in the air flow direction respectively, thereby regulating open areas of the corresponding air outlets 19 to 21.

The defroster door 22, the face door 23 and the foot door 24 are adopted as an example of an outlet mode switching portion which switches an air outlet mode. These three doors 22, 23, 24 are coupled to a servomotor 25 through a non-illustrated link mechanism, thereby being operated rotationally and integrally. An operation of the servomotor 25 is also controlled by a control signal output from the air conditioning controller 30.

The air outlet mode includes a face mode, a bi-level mode, a foot mode and a foot/defroster mode. In the face mode, the face air outlet 20 is fully opened so that conditioned air is blown toward the upper side of the passenger in the vehicle compartment from the face air outlet 20. In the bi-level mode, both the face air outlet 20 and the foot air outlet 21 are opened so that conditioned air is blown toward the upper and lower sides of the passenger in the vehicle compartment. In the foot mode, the foot air outlet 21 is fully opened and the defroster air outlet 19 is opened by a small open degree so that conditioned air is mainly blown from the foot air outlet 21. In the foot/defroster mode, the foot air outlet 21 and the defroster air outlet 19 are opened by approximately same open degree so that conditioned air is blown from both the foot air outlet 21 and the defroster air outlet 19.

Furthermore, as the air outlet mode, a defroster mode can be set, in which the defroster air outlet 19 is fully opened so that conditioned air is blown toward the inner surface of the windshield of the vehicle from the defroster air outlet 19, when the passenger manually controls switches of an operation panel 50.

An electrical control portion of the present embodiment will be described below. The air conditioning controller 30 includes a known microcomputer and its peripheral circuit. The microcomputer includes a central processing unit (CPU), a read-only memory (ROM), and a random-access memory (RAM). The air conditioning controller 30 performs a variety of calculations and processes based on an air conditioning control program stored in the ROM, and controls operations of various devices connected to an output side of the air conditioning controller 30.

The output side of the air conditioning controller 30 is connected to air conditioning control devices such as the servomotors 7, 18, and 25, the electrical motor 8b, the inverter 40 for the electrical motor 11b, and the electrical motor 12c.

An input side of the air conditioning controller 30 is connected to a sensor group, which is used for controlling air conditioning. The sensor group includes an outside air sensor 31, an inside air sensor 32, a solar sensor 33, an evaporator temperature sensor 34 (cooling temperature detector), a coolant temperature sensor 35, and a dew-point detector 36. The outside air sensor 31 detects an outside air temperature Tam, and the inside air sensor 32 detects an inside air temperature Tr of the vehicle compartment. The solar sensor 33 detects a solar radiation amount Ts entering into the vehicle compartment, and the evaporator temperature sensor 34 detects a temperature Te (cooling temperature of the blown air) of air immediately after flowing out of the evaporator 9. The coolant temperature sensor 35 detects a temperature Tw of coolant flowing out from the engine, and the dew-point detector 36 detects a dew-point temperature Tdew of air flowing into the evaporator 9.

For example, the evaporator temperature sensor 34 of the present embodiment detects a temperature of a fin in a heat exchanging portion of the evaporator 9. As the evaporator temperature sensor 34, a temperature detector may be adopted, which detects a temperature of another part of the evaporator 9, or which directly detects a temperature of refrigerant flowing in the evaporator 9. Furthermore, a temperature detector, which detects a temperature of air immediately after flowing out of the evaporator 9, also may be adopted.

The dew-point detector 36 of the present embodiment may be configured to include a humidity sensor which detects a relative humidity Rein of air flowing into the evaporator 9, and a temperature sensor which detects a temperature Tein of air flowing into the evaporator 9. The humidity sensor and the temperature sensor may be incorporated into the dew-point detector 36 to output a relative humidity Rein and a temperature Tein of air flowing into the evaporator 9.

The relative humidity Rein and the temperature Tein of air flowing into the evaporator 9 are examples of physical amounts relevant to the dew-point temperature Tdew of air flowing into the evaporator 9. A humidity sensor and a temperature sensor, which are separately provided, may be adopted to detect the physical amounts without using the dew-point detector 36. In this case, the air conditioning controller 30 calculates the dew-point temperature Tdew based on detection values of the humidity sensor and the temperature sensor.

Additionally, the input side of the air conditioning controller 30 is connected to the operation panel 50 arranged near the instrument panel located at the front end of the vehicle compartment. Operation signals output from various air-conditioning operation switches provided at the operation panel 50 are input to the input side of air conditioning controller 30.

Specifically, the air-conditioning operation switches provided at the operation panel 50 includes an air-conditioner switch 51, a temperature setting switch 52, an air outlet mode switch 53, an inside/outside air selecting switch 54, a blower operation switch 55, an automation switch 56. The air-conditioner switch 51 is used for outputting an operation command signal of the compressor 11, the temperature setting switch 52 is used as an example of a temperature setting portion which sets a temperature Tset of the vehicle compartment. The air outlet mode switch 53 is used for manually setting the air outlet mode which is switched by selectively opening and closing the air outlet doors 22 to 24. The inside/outside air selecting switch 54 is used for manually setting the air inlet mode which is switched by selectively opening and closing the inside/outside air switching door 6. The blower operation switch 55 is used for manually changing an air blowing amount of the blower 8, and the automation switch 56 is used for performing or terminating an automatic control of the air conditioner 100.

Furthermore, a switch group 60 is connected to the input side of the air conditioning controller 30. The switch group 60 detects an opening or closing state of an air pathway, through which outside air can flow into the vehicle compartment from outside, except for the switching box 5. The switch group 60 includes a door switch 61 and a window switch 62, for example. The door switch 61 is used for detecting an opening or closing state of an incoming/outgoing door through which a passenger (driver) gets in or out the vehicle compartment. The window switch 62 is used for controlling open/close of a sun roof or a window which is attached to the incoming/outgoing door. Signals output from the switches 61 and 62 are input to the input side of the air conditioning controller 30.

The air conditioning controller 30 is configured to include control portions which control the above-described air conditioning control components 7, 8b, 12c, 18, 25, and 40. In the present embodiment, for example, a cooling temperature control portion 30a is adopted as a control portion (a hardware and a software), which controls the operation of the electrical motor 11b (specifically, the inverter 40) of the compressor 11 adopted as the cooling temperature adjusting portion. An inside/outside air switch control portion 30b is adopted as a control portion (a hardware and a software), which controls the servomotor 7 of the switching door 6 of the inside/outside air switching portion (5).

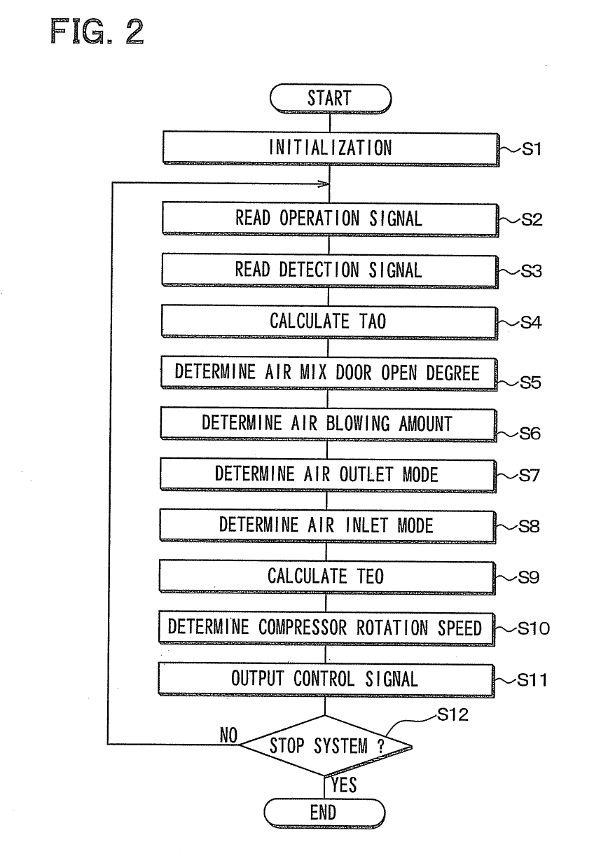

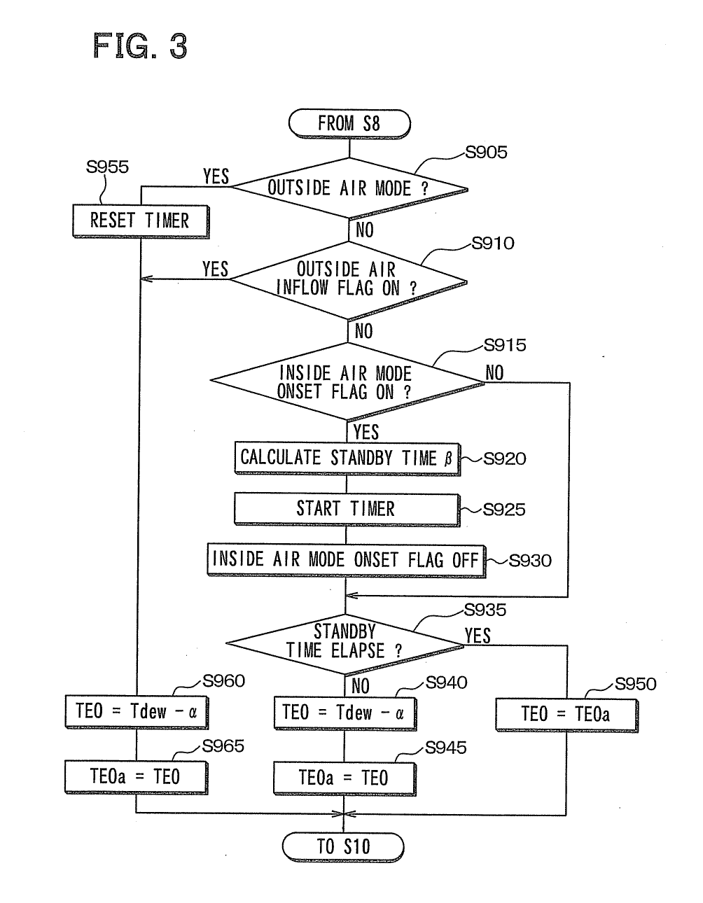

An operation of the air conditioner 100 will be described referring to FIGS. 2 and 3. Each of control steps in FIGS. 2 and 3 is a part of an implementation portion of various functions of the air conditioning controller 30. The control process starts when the automation switch 56 is switched ON in a state where the air-conditioner switch 51 of the operation panel 50 is switched ON.

At step S1, initialization of a flag, a timer, and the like is performed. In the initialization, some of flags and calculated values, which are stored at the last termination of a control operation of the air conditioner 100, are maintained.

At step S2, operation signals from the operation panel 50 are input, and next at step S3, signals of a vehicle-environmental state such as detection signals of the sensor group 31 to 36, operation signals of the switch group 60, and the like are input. The switch group 60 is configured to detect the opening or closing state of the air pathway, through which outside air can flow into the vehicle compartment from outside, except for the switching box 5.

At step S3, when a signal input from at least one of the switches of the switch group 60 denotes the opening state of the air pathway, an outside-air inflow flag is turned ON. The ON state of the outside-air inflow flag indicates a state where outside air can flow into the vehicle compartment from outside without through the inside/outside air switching box 5. When signals input to the air conditioning controller 30 from all the switches of the switch group 60 indicate the closing state, the outside-air inflow flag is turned OFF.

At step S4, a target outlet air temperature TAO of air blown into the vehicle compartment is calculated. The target outlet air temperature TAO is calculated by using the following formula F1.

TAO=Kset×Tset−Kr×Tr−Kam×Tam−Ks×Ts+C (F1)

Here, Tset is a set temperature of the vehicle compartment set by the temperature setting switch 52, Tr is a temperature inside the vehicle compartment (inside air temperature) detected by the inside air sensor 32, Tam is a temperature outside the vehicle compartment (outside air temperature) detected by the outside air sensor 31, and Ts is a solar radiation amount detected by the solar sensor 33. Furthermore, Kset, Kr, Kam and Ks are gains, and C is a constant value for a correction.

At subsequent steps S5 to S10, control states of the various devices connected to the air conditioning controller 30 are determined. At step S5, a target open degree SW of the air mix door 17 (e.g., a control signal output from the air conditioning controller 30 to the servomotor 18 of the air mix door 17) is calculated based on the target outlet air temperature TAO, the air temperature Te detected by the evaporator temperature sensor 34, and a coolant temperature Tw detected by the coolant temperature sensor 35, by using the following formula F2.

SW=[(TAO−Te)/(Tw−Te)]×100(%) (F2)

SW=0(%) indicates that the air mix door 17 is in a maximum cooling state, where the bypass passage 16 is fully opened and a heating air passage through which air passes through the heater core 15 is fully closed. In contrast, SW=100(%) indicates that the air mix door is in a maximum heating state, where the bypass passage 16 is fully closed and the heating air passage is fully opened.

At step S6, an air blowing amount blown by the blower 8 (e.g., a control voltage output from the air conditioning controller 30 to the electrical motor 8a) is determined. The control voltage is determined based on the target outlet air temperature TAO, so as to be larger voltage in a high or low TAO relative to in a middle TAO, based on a control map which is preliminarily stored in the air conditioning controller 30.

At step S7, the air outlet mode is determined. The air outlet mode is determined also based on the target outlet air temperature TAO by using a control map stored in the air conditioning controller 30. In the present embodiment, the air outlet mode is switched from the foot mode to bi-level (B/L) mode, and then to the face mode, as the TAO increases from a low to high temperature region.

At step S8, the air inlet mode is determined by setting a switching state of the inside/outside air switching box 5. The air inlet mode is determined also based on the TAO by using a control map stored in the air conditioning controller 30. In the present embodiment, the outside air mode is generally preferentially set, where outside air is introduced. However, the inside air mode, where inside air is introduced, is selected when the TAO becomes extremely low temperature, i.e., when high cooling performance is required.

Here, at step S8, an inside air mode onset flag is turned ON when the air inlet mode is switched to the inside air mode at the first time. The ON state of the inside air mode onset flag indicates an onset of the inside air mode. However, the inside air mode onset flag is not turned ON from the second time after the inside air mode is selected first.

At step S9, the target cooling temperature TEO of air blown out of the evaporator 9 is determined. The control operation of step S9 of the present embodiment is adopted as a target temperature determining portion for determining a target cooling temperature TEO which is a target value of a cooling temperature Te of air in the evaporator 9.

Details of the control operation of step S9 will be described referring to FIG. 3.

At step S905, it is determined whether the air inlet mode determined at step S8 is the outside air mode. Consequently, when the air inlet mode is determined not to be the outside air mode, a control operation of step S910 is performed. When the air inlet mode is determined to be the outside air mode, a control operation of step S955 is performed. When the air inlet mode is determined to be the inside/outside air mix mode, the control operation of step S955 is performed similar to the outside air mode.

At step S910, it is determined whether outside air can flow into the vehicle compartment from outside without through the switching box 5. The control operation of step S910 of the present embodiment is adopted as an outside air inflow determining portion which determines whether outside air can flow into the vehicle compartment from outside without through the switching box 5 in the inside air mode. Specifically, at step S910, it is determined whether the outside-air inflow flag set at step S3 is ON.

When the outside-air inflow flag is determined not to be ON at step S910, i.e., when the outside-air inflow flag is determined to be OFF, a control operation of step S915 is performed. When the outside-air inflow flag is determined to be ON, a control operation of step S960 is performed.

At step S915, it is determined whether the air conditioner 100 is immediately after the inside air mode, namely, whether it is a start timing of the inside air mode. Specifically, it is determined whether the inside air mode onset flag is ON. The inside air mode onset flag indicates that the inside air mode is selected at the first time, as the air inlet mode.

When the inside air mode onset flag is determined to be ON at step S915, a control operation of step S920 is performed. At step S920, a standby time β (base time) is calculated, which is required for humidity difference around the dew-point detector 36 to decrease, and for humidity around the dew-point detector 36 to become an average humidity in the vehicle compartment, i.e., which is required for the dew-point temperature Tdew to stabilize after the inside air mode is selected.

Specifically, the standby time β can be calculated based on a volume of the vehicle compartment and a flow amount of blown air by using a control map, which defines a relationship between the volume of the vehicle compartment, the blowing amount, and the standby time β. The control map is configured such that the larger the volume of the vehicle compartment and the smaller the air blowing amount, the longer the standby time β becomes.

At step S925, a timer provided in the air conditioning controller 30 starts counting since the inside air mode is selected. Next, at step S930, the inside air onset flag is turned OFF, and then a control operation of step S935 is performed.

When the inside air mode onset flag is determined not to be ON at step S915, the control processes of steps S920 to S930 are skipped and the control operation of step S935 is performed.

At step S935, it is determined whether the standby time β elapses after the inside air mode is selected. Specifically, at step S935, it is determined whether the counting time of the timer started at step S925 has passed the standby time β. Consequently, when the standby time β does not elapse after the inside air mode is selected, a control operation of step S940 is performed.

At step S940, the target cooling temperature TEO of air blown out from the evaporator 9 is set to be lower than a dew-point temperature Tdew by a standard degree α. Specifically, the target cooling temperature TEO (Tdew−α) is set by subtracting a predetermined standard degree a from a dew-point temperature Tdew detected by the dew-point detector 36. The standard degree α is a margin of error, and is set to be 2° C., for example.

At step S945, the target cooling temperature TEO calculated at step S940 is stored in the storage portion (ROM) of the air conditioning controller 30 as a target cooling temperature TEOa, and then a control operation of step S10 is performed. The TEOa is updated every when the target cooling temperature TEO is newly calculated at step S940.

When the standby time β of the timer is determined at step S935 to elapse after the inside air mode is selected, a control operation of step S950 is performed. At step S950, the target cooling temperature TEO is determined to be a target cooling temperature TEOa, which is determined when the standby time β elapses after the inside air mode is selected, and then the control operation of step S10 is performed.

Then, the TEOa stored in the storage portion of the air conditioning controller 30, i.e., a target cooling temperature TEO calculated at step S940 at the last time, is set as a new target cooling temperature TEO at the present time, at step S950. Namely, a value (fixed value) of target cooling temperature, which is calculated at a timing at which the standby time β elapses after the inside air mode is selected, is determined as the target cooling temperature TEO at step S950.

Accordingly, the target cooling temperature TEO is maintained at a target temperature, which is determined when the standby time β has passed after the inside air mode is selected, basically without depending on the dew-point temperature Tdew.

When the air inlet mode is determined to be the outside air mode at step S905, a control operation of step S955 is performed. At step S955, the timer, which counts from when the inside air mode is selected, is reset.

After the timer is reset at step S955, or when the outside-air inflow flag is determined to be ON at step S910, a control operation of step S960 is performed. At step S960, similar to step S940, the target cooling temperature TEO of air blown out of the evaporator 9 is set to be lower than the dew-point temperature Tdew by the standard degree α.

At step S965, the target cooling temperature TEO calculated at step S960 is stored in the storage portion (ROM) of the air conditioning controller 30 as a target cooling temperature TEOa, and then the control operation of step S10 is performed. The TEOa is updated every when the target cooling temperature TEO is newly calculated at step S960.

For example, when the outside-air inflow flag is switched from ON to OFF in the case where the standby time β elapses after the inside air flow mode is selected, the control operations are performed in an order of steps S910, S915, S935, and S950. In this case, at step S950, the present target cooling temperature TEO is determined to be the TEOa, which has been stored in the storage portion at step S965 immediately before the outside-air inflow flag is switched from ON to OFF. When the outside-air inflow flag is changed such that OFF→ON→OFF in the inside air mode, the target cooling temperature TEO, which is determined after the outside-air inflow flag is finally turned to be OFF, is maintained at the target cooling temperature TEOa, that is set immediately before the outside-air inflow flag is switched from ON to OFF.

At step S10, a rotation speed (a control voltage output from the inverter 40 to the electrical motor 11b) of the compressor 11, i.e., a refrigerant discharge capacity of the compressor 11 is determined. Specifically, a deviation En (=Te−TEO) between the air temperature Te and the target cooling temperature TEO determined at step S9 is calculated at first. And then, based on the calculated deviation En, a control voltage output from the inverter 40 is determined by a feedback control method using a proportional-integral control (PI control), so that the air temperature Te approaches the target cooling temperature TEO.

In the air conditioner 100 of the present embodiment, the cooling temperature control portion 30a of the air conditioning controller 30 controls an operation of the compressor 11, so that the air temperature Te (air temperature cooled by the evaporator 9) approaches a target cooling temperature TEO. In the present embodiment, the lowest temperature of the target cooling temperature TEO is set to be equal to or larger than 0° C. (e.g., the lowest temperature is set to be 1° C.), so that frost formation at the evaporator 9 is prevented.

At step S11, control signals or the like are output from the air conditioning controller 30 to the air conditioning control components 7, 8b, 12c, 18, 25, and 40, so that the control states determined at above-described steps S5 to S10 are set. Next at step S12, it is determined whether a termination signal for stopping the operation of the air conditioner 100 is output from the operation panel 50.

When the termination signal is determined to be output at step S12, the operation of the air conditioner 100 is stopped. When the termination signal is determined not to be output, the operation waits for a control period τ (e.g., about 250 ms), and after a determination of the elapse of control period τ, the operation returns to step S2.

Because the air conditioner 100 according to the present embodiment is operated as described above, refrigerant evaporates in the evaporator 9 by absorbing heat from air blown from the blower 8, thereby cooling air blown from the blower 8. Cold air cooled by the evaporator 9 flows into the heating air passage of the heater core 15 and/or the bypass passage 16 depending on an open state of the air mix door 17.

Cold air flowing into the heating air passage is reheated at the heater core 15, and then mixed with cold air which passes through the bypass passage 16 while bypassing the heater core 15, so that temperature of air is conditioned. The conditioned air is blown into the vehicle compartment through the air outlets 19 to 21. Accordingly, when the inside air temperature Tr in the vehicle compartment becomes lower than the outside air temperature Tam, cooling of the vehicle compartment can be performed. On the other hand, when the inside air temperature Tr in the vehicle compartment becomes higher than an outside air temperature Tam, heating of the vehicle compartment can be performed.

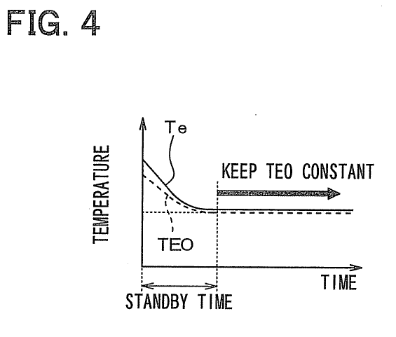

As shown in FIG. 4, in the air conditioner 100 of the present embodiment, the target cooling temperature TEO is maintained at a constant value on the basis of the dew-point temperature Tdew when the predetermined standby time β (base time) elapses after the inside air mode is selected. The dew-point temperature Tdew used as the basis is detected when the standby time β has passed. The maintenance of the target cooling temperature TEO is performed at step S9 which is adopted as the target temperature determining portion.

In the present embodiment, as shown FIG. 4, the target cooling temperature TEO is maintained at the constant value when the predetermined standby time β (base time) elapses after the inside air mode is selected. Thus, the dew-point temperature Tdew of air flowing into the evaporator 9 can be prevented from reducing. The reduction of the dew-point temperature Tdew is generally caused by circulation of air dehumidified at the evaporator 9. Accordingly, it can prevent the temperature of air from being unnecessarily cooled at the evaporator 9 in the inside air mode. Therefore, energy expenditure (e.g., driving power consumed at the compressor 11) for cooling air can be also prevented from increasing.

Because the dew-point temperature Tdew of air flowing into the evaporator 9 can be prevented from reducing, the target cooling temperature TEO can be maintained lower than the dew-point temperature Tdew. Therefore, even if a target cooling temperature TEO is maintained at a constant value, an outer surface of the evaporator 9 can be kept at a moist state.

Hence, increment of energy consumed in the whole of the air conditioner 100 can be prevented, and generation of bad odor from air blown into the vehicle compartment also can be prevented.

For example, when the incoming/outgoing door or the window of the vehicle is opened, outside air (air outside the vehicle compartment) may flow into the vehicle compartment and then humidity of inside air (air inside the vehicle compartment) may change even in the inside air mode.

In this case, if the target cooling temperature TEO is maintained at a constant value on the basis of the dew-point temperature Tdew, energy consumed in the air conditioner 100 may be increased or bad odor from blown air may be caused. Here, the dew-point temperature Tdew is detected when a predetermined time elapses after air conditioning of the vehicle compartment starts.

For example, when the dew-point temperature Tdew increases due to inflow of outside air flowing to the vehicle compartment, a temperature difference between the dew-point temperature Tdew and the target cooling temperature TEO may enlarge. Thus, air flowing out of the evaporator 9 may be cooled much unnecessarily, and thereby driving power consumed at the compressor 11 may be consumed much unnecessarily. On the other hand, when the dew-point temperature Tdew decreases due to inflow of outside air to the vehicle compartment, the target cooling temperature TEO may become greater than the dew-point temperature Tdew. Hence, the outside of the evaporator 9 may become dry, and bad odor may be generated in blown air.

In response, in the present embodiment, a target cooling temperature TEO is determined depending on the dew-point temperature Tdew of air flowing into the evaporator 9 when outside air can flow into the vehicle compartment in the inside air mode. Accordingly, increment of energy consumed in the air conditioner 100 and bad odor generation in air, which are caused by inflow of outside air to the vehicle compartment, are prevented in the inside air mode.

Moreover, in the present embodiment, the target cooling temperature TEO is maintained at a constant value when humidity difference around the dew-point detector 36 decreases after air conditioning of the vehicle compartment starts. Therefore, it can prevent the target cooling temperature TEO from becoming unnecessarily high or low due to the humidity difference around the dew-point detector 36.

Furthermore, in the present embodiment, a dew-point temperature Tdew of air flowing into the evaporator 9 is prevented from reducing in the inside air mode. Thus, air flowing into the evaporator 9 can be prevented from being dehumidified excessively in the inside air mode.

Accordingly, the air conditioner 100 of the present embodiment can be suitably used for a hybrid vehicle. The reason is that a hybrid vehicle has a running state where its engine is stopped in running. In such a running state, it is difficult to heat coolant sufficiently, which is used as a heat source of the heater core 15, and thereby, it is difficult to increase a temperature of blown air, which has been cooled much, to a target outlet air temperature TAO.

### Second Embodiment

A second embodiment of the invention will be described. In the above-described first embodiment, a target cooling temperature TEO is determined based on humidity change of inside air in the inside air mode. The humidity change is caused by inflow of outside air to the vehicle compartment.

However, for example, breathing and sweating of a passenger or an operation of a humidifier or the like may be one of reasons for humidity change of inside air in the inside air mode. When humidity of inside air changes in the inside air mode, the dew-point temperature Tdew of air flowing into the evaporator 9 also changes.

Thus, when humidity of inside air changes in the inside air mode, and when a target cooling temperature TEO is maintained at a constant value on the basis of the dew-point temperature Tdew, energy consumed in the air conditioner 100 may increase and bad odor in air may cause. The dew-point temperature Tdew is detected when predetermined time elapses after air conditioning of the vehicle compartment starts.

In the second embodiment, when the target cooling temperature TEO is determined in the inside air mode, a temperature change ratio (temperature change per unit time) of the dew-point temperature Tdew of air flowing into the evaporator 9 is also considered, in addition to inside-air humidity change due to inflow of outside air to the vehicle compartment.

Specifically, in the present embodiment, in the inside air mode, a dew-point temperature Tdew of air flowing into the evaporator 9 is stored every control cycle. Based on the stored dew-point temperature Tdew, a temperature change ratio of the present dew-point temperature Tdew of air flowing into the evaporator 9 is calculated. The temperature change ratio can be determined based on a change ratio between the last dew-point temperature Tdew and the present dew-point temperature Tdew. However, a calculation method is not limited to this. For example, a temperature change ratio may be calculated based on the present dew-point temperature Tdew and a dew-point temperature Tdew detected several times ago.

When a temperature change ratio of the dew-point temperature Tdew exceeds a predetermined value in the inside air mode, the target cooling temperature TEO of air blown out of the evaporator 9 is set to be lower then a dew-point temperature Tdew by a standard degree α at steps S960. S940 in FIG. 3. The predetermined value indicates a change ratio determined when the dew-point temperature Tdew changes drastically by breathing and sweating of a passenger or an operation of a humidifier, and the predetermined value is determined by an experiment or a simulation in advance.

As described above, in the present embodiment, a target cooling temperature TEO is determined depending on the dew-point temperature Tdew of air flowing into the evaporator 9 when a temperature change ratio of a dew-point temperature Tdew is high in the inside air mode. Accordingly, increment of energy consumed in the air conditioner 100 and bad odor generation in air, which are caused by humidity change in the vehicle compartment, are prevented in the inside air mode.

Moreover, in the present embodiment, a target cooling temperature TEO is maintained at a constant value when humidity difference around the dew-point detector 36 decreases after air conditioning of the vehicle compartment starts. Therefore, it can prevent the target cooling temperature TEO from becoming higher or lower than necessary due to the humidity difference around the dew-point detector 36.

In the second embodiment, the other parts may be similar to those of the above-described first embodiment.

### Third Embodiment

A third embodiment of the invention will be described. Breathing or/and sweating of a passenger may greatly affect humidity of the vehicle compartment in the inside air mode. Thus, in the present embodiment, the number of passengers on the vehicle is also considered at step S9 in FIG. 2 when the target cooling temperature TEO is determined, in addition to the dew-point temperature Tdew of air flowing into the evaporator 9. The step S9 is adopted as the target temperature determining portion.

Specifically, in the present embodiment, at steps S940 and S960, the target cooling temperature TEO is determined by subtracting a standard degree α′ from a dew-point temperature Tdew (TEO=Tdew−α′). The standard degree α′ is set depending on the number of passengers on the vehicle. The number of passengers on the vehicle can be estimated based on a signal from a seating sensor or a seat belt sensor or the like. The seating sensor is embedded in a seat of the vehicle and detects whether a passenger sits on the seat. The seat belt sensor detects whether a seat belt is fastened or not.

The standard degree α′ can be calculated based on a signal from the seat sensor or the seat belt sensor or the like, by using a control map which defines a relationship between the standard degree α′ and the number of passengers. The control map is stored in the storage portion such as the ROM of the air conditioning controller 30.

A humidification amount in the vehicle compartment increases with increasing the number of passengers. Thus, the standard degree α′ is set to increase with increasing the number of passengers. For example, when the number of passengers is large (e.g., 5 passengers), the standard degree α′ is set to be high relative to when the number of passengers is small (e.g., 1 passenger). Therefore, when the number of passengers is large, the target cooling temperature TEO is set to be low relative to when the number of passengers is small.

Accordingly, the target cooling temperature TEO can be determined based not only on the dew-point temperature Tdew of air flowing into the evaporator 9 but also on the standard degree α′ in the inside air mode. Here, the standard degree α′ is determined based on a humidity change in the vehicle compartment. Therefore, the vehicle compartment can be prevented from being dehumidified excessively.

In the third embodiment, the other parts may be similar to those of the above-described first embodiment.

### Other Embodiments

The invention is not limited to the above-described embodiments. Unless departing the scope described in each claim, the invention is not limited to the tenor described in each claim. The invention extends into a scope where a person skilled in the art can substitute easily. A refinement based on knowledge, that a person skilled in the art generally has, can be added arbitrarily to the invention. For example, the invention can be modified variously as below.

(1) In the above-described embodiments, the relative humidity Rein and the temperature Tein of air flowing into the evaporator 9 are detected by the dew-point detector 36 including the humidity sensor and the temperature sensor, but the air conditioner 100 of the invention is not limited to this. For example, a humidity sensor and a temperature sensor, which are provided separately, may be adopted without using the dew-point detector 36. In this case, the air conditioning device 30 may calculate the dew-point temperature Tdew based on detection values from the humidity and temperature sensors which are provided separately. Moreover, two humidity sensors may be provided to detect humidity of inside air and outside air respectively, and the two humidity sensors may be used separately depending on the air inlet mode.

(2) In the above-described second embodiment, in the inside air mode, the target cooling temperature TEO is determined based on the inside-air humidity change due to inflow of outside air to the vehicle compartment and based on the temperature change ratio (temperature change per unit time) of the dew-point temperature Tdew of air flowing into the evaporator 9. However, a determination of the target cooling temperature TEO is not limited to this. The target cooling temperature TEO may be determined based only on the temperature change ratio (temperature change per unit time) of the dew-point temperature Tdew of air flowing into the evaporator 9 in the inside air mode, without using the inside-air humidity change due to inflow of outside air to the vehicle compartment.

(3) In the above-described embodiments, the compressor 11 is adopted as the cooling temperature adjusting portion, but the cooling temperature adjusting portion is not limited to this. A variable throttle mechanism used as the decompression portion of the refrigerant cycle 10 can be adopted as the cooling temperature adjusting portion, when the evaporator 9 of the refrigerant cycle 10 is adopted as the cooling heat exchanger as with the above-described embodiments. In this case, the evaporation temperature of refrigerant flowing at the evaporator 9, i.e., the cooling temperature can be adjusted by regulating an open degree of the variable throttle mechanism.

(4) In the above-described embodiments, the evaporator 9 of the refrigerant cycle 10 is adopted as the cooling heat exchanger, but the cooling heat exchanger is not limited to this. For example, an evaporator which evaporates refrigerant (heat medium) in an adsorption refrigerator or an absorption refrigerator may be adopted as the cooling heat exchanger. A heat exchanger having a Peltier module, which exerts cooling performance by Peltier effect, may be also adopted as the cooling heat exchanger.

(5) In the above-described embodiments, the air conditioner 100 of the invention is used for a hybrid vehicle in which driving force is obtained from both of an engine and an electrical motor, but the air conditioner 100 may be applied to another type of vehicle, such as a vehicle in which driving force is obtained only from an engine.

Additional advantages and modifications will readily occur to those skilled in the art. The invention in its broader terms is therefore not limited to the specific details, representative apparatus, and illustrative examples shown and described.

What is claimed is:

1. An air conditioner for a vehicle, comprising:
a casing defining an air passage through which air to be blown into a vehicle compartment passes;
an inside/outside air switching portion arranged to switch between an inside air mode, where air inside the vehicle compartment is introduced into the casing, and an outside air mode, where air outside the vehicle compartment is introduced into the casing;
a cooling heat exchanger arranged in the casing to cool air;
a cooling temperature adjusting portion configured to adjust a cooling temperature of air cooled at the cooling heat exchanger;
a dew-point detector configured to detect a physical amount relevant to dew-point temperature of air flowing to the cooling heat exchanger;
a target temperature determining portion configured to determine a target cooling temperature which is a target temperature of the cooling heat exchanger;
a cooling temperature control portion configured to control the cooling temperature adjusting portion so that the cooling temperature approaches the target cooling temperature; and
an inside/outside air switch control portion configured to control an operation of the inside/outside air switching portion, wherein
the target temperature determining portion sets the target cooling temperature to be lower than the dew-point temperature before a base time elapses when the inside air mode is selected by the inside/outside air switching portion, and
the target temperature determining portion maintains the target cooling temperature at a target cooling temperature, which is set at the elapse of the base time, after the base time elapses when the inside air mode is selected.

2. The air conditioner according to claim 1, further comprising
an outside air inflow determining portion configured to determine whether air outside the vehicle compartment is able to flow into the vehicle compartment when the inside air mode is selected by the inside/outside air switching portion,
wherein the target temperature determining portion sets the target cooling temperature to be lower than the dew-point temperature when the outside air inflow determining portion determines that air outside the vehicle compartment is able to flow into the vehicle compartment in the inside air mode.

3. The air conditioner according to claim 1, wherein the target temperature determining portion sets the target cooling temperature to be lower than the dew-point temperature when a temperature change ratio of the dew-point temperature exceeds a predetermined value, in a case where the inside air mode is selected by the inside/outside air switching portion.

4. The air conditioner according to claim 1, wherein the target temperature determining portion sets the target cooling temperature to be lower than the dew-point temperature when an outside air mode is selected by the inside/outside air switching portion.
